(19) United States
(12) Patent Application Publication
(10) Pub. No.: US 2025/0084003 A1
(43) Pub. Date: Mar. 13, 2025

(54) POLYCRYSTALLINE CUBIC BORON NITRIDE COMPOSITE SHEET HAVING CONTINUOUS GRADIENT STRUCTURE AND PREPARATION METHOD THEREOF

(71) Applicants: CENTRAL SOUTH UNIVERSITY, Changsha (CN); SF DIAMOND CO., LTD., ZHENGZHOU (CN)

(72) Inventors: Shaohe ZHANG, Changsha (CN); Linglong RONG, Changsha (CN); Dongpeng ZHAO, Zhengzhou (CN); Xiangwang KONG, Changsha (CN); Jingjing WU, Changsha (CN); Haoyang ZHANG, Changsha (CN); Hua GAO, Zhengzhou (CN); Jincheng LI, Zhengzhou (CN); Mengyao SHAO, Zhengzhou (CN); Changjian GENG, Zhengzhou (CN)

(73) Assignees: CENTRAL SOUTH UNIVERSITY, Changsha (CN); SF DIAMOND CO., LTD., ZHENGZHOU (CN)

(21) Appl. No.: 18/611,629

(22) Filed: Mar. 20, 2024

(30) Foreign Application Priority Data
Sep. 13, 2023 (CN) 202311177986.5

(51) Int. Cl. C04B 35/5831; C04B 35/626; C04B 35/636; C04B 35/645

(52) U.S. Cl. CPC C04B 35/5831; C04B 35/6261; C04B 35/6365; C04B 35/645; C04B 2235/3817; C04B 2235/386; C04B 2235/5427; C04B 2235/5436; C04B 2235/5445; C04B 2235/60; C04B 2235/6567; C04B 2235/658

(57) ABSTRACT

The disclosure discloses a polycrystalline cubic boron nitride composite sheet having a continuous gradient structure and a preparation method thereof. The polycrystalline cubic boron nitride composite sheet consists of a cemented carbide substrate, a continuous gradient layer, and a CBN layer from bottom to top. The continuous gradient layer contains cemented carbide and CBN, a content of CBN increases in continuous gradient from bottom to top, while a content of the cemented carbide decreases in continuous gradient from bottom to top. A volume fraction D of CBN and a volume fraction M of cemented carbide in the continuous gradient layer both satisfy exponential gradient functions. At the same time, the disclosure uses direct ink writing 3D printing technology with slurry to realize the preparation of the polycrystalline cubic boron nitride composite sheet having the continuous gradient structure.

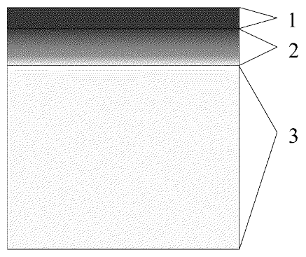

### CROSS-REFERENCE TO RELATED APPLICATION

This application claims the priority benefit of China application serial no. 202311177986.5, filed on Sep. 13, 2023. The entirety of the above-mentioned patent application is hereby incorporated by reference herein and made a part of this specification.

### BACKGROUND

### Technical Field

The disclosure belongs to the technical field of superhard material preparation, and specifically relates to a polycrystalline cubic boron nitride composite sheet having a continuous gradient structure and a preparation method thereof.

### Description of Related Art

Cubic boron nitride (CBN) is the second superhard material after diamond, which has unique physical and chemical properties. The composite sheet thereof is widely used in cutting tools, especially in steel, cast iron, etc., which is something that diamond composite sheets are not comparable. PCBN composite sheet is a multi-phase structural material in which a layer of CBN is sintered on a WC—Co substrate. Due to the sintering process and the composite nature of the material, the thermal expansion coefficient mismatch inevitably produces residual thermal stress. When cooling from the sintering temperature to the room temperature, CBN and binder Co shrink to varying degrees, causing phenomena such as elastic bending and stretching of the two-phase lattice, thereby generating microscopic residual thermal stress inside the CBN layer in PCBN. On the whole, the mismatch in expansion coefficients between the CBN layer and the cemented carbide substrate generates macroscopic residual thermal stress, which is likely to cause cracks at the interface between the CBN layer and the cemented carbide substrate during use, leading to the phenomenon of failure from the CBN layer falling off, cracking, and gradually losing cutting ability.

In order to solve this problem, in the polycrystalline cubic boron nitride composite sheet having the functional gradient structure, through adding several to more than a dozen gradient layers between the CBN layer and the cemented carbide substrate, gradient transition is used to ease the difference in thermal expansion coefficients between the two materials to reduce the internal residual thermal stress between the two different materials, thereby improving the bonding strength between the interfaces. However, the layered gradient structure has certain flaws. If it is desired to significantly alleviate the residual stress by using the layered gradient structure, it is necessary to increase the quantity of gradient layers. A large quantity of layers leads to too many interfaces, and the defect of weak bonding strength at the interfaces is further amplified.

### SUMMARY

In view of the problems and deficiencies in the above-mentioned related art, the first purpose of the disclosure is to provide a polycrystalline cubic boron nitride composite sheet having a continuous gradient structure. By setting the continuous gradient layer between the CBN layer and the cemented carbide substrate, volume fractions of the two materials change gradually and continuously according to exponential function within one layer, and there is no notable layered interface between the components, thereby solving the problem of too many interfaces in the layered gradient structure and greatly reducing the residual stress.

The second purpose of the disclosure is to provide a preparation method of the polycrystalline cubic boron nitride composite sheet having the continuous gradient structure. The method uses direct ink writing 3D printing technology with slurry to realize the preparation of the polycrystalline cubic boron nitride composite sheet having the continuous gradient structure, which has advantages such as simple process flow and high precision.

In order to achieve the above purposes, the disclosure provides a polycrystalline cubic boron nitride composite sheet having a continuous gradient structure, the polycrystalline cubic boron nitride composite sheet consists of a cemented carbide substrate, a continuous gradient layer, and a CBN layer from bottom to top, the continuous gradient layer includes cemented carbide and CBN, a content of the CBN increases in continuous gradient from bottom to top, and a content of the cemented carbide decreases in continuous gradient from bottom to top. In the continuous gradient layer, at a height h and from bottom to top, a volume fraction D of the CBN and a volume fraction M of the cemented carbide satisfy gradient functions (1) and (2) respectively below.

$$D = {( \frac{h}{H} )}^{n} , 0 ≦ h ≦ H \qquad ( 1 )$$

$$M = 1 - {( \frac{h}{H} )}^{n} , 0 ≦ h ≦ H \qquad ( 2 )$$

In the functions, H is a total height of the continuous gradient layer, and n is an exponent of the gradient functions.

In a preferred solution, the total height H of the continuous gradient layer is 0.05 to 5 mm, and the exponent n of the gradient functions is greater than or equal to 1.

In the polycrystalline cubic boron nitride composite sheet provided by the disclosure, by setting a continuous gradient layer between the CBN layer and the cemented carbide substrate, volume fractions of the two materials change continuously within one layer, and there is no notable layered interface, thereby the problem of too many interfaces in the layered gradient structure is solved, the residual thermal stress is significantly reduced, the bonding strength of the gradient structure cubic boron nitride composite sheet is improved, and the quality risk of delamination of the polycrystalline cubic boron nitride layer and the cemented carbide substrate in actual use is reduced. In addition, through the provided functional relationships of the volume fraction of CBN and the volume fraction of cemented carbide, the continuous gradient layer can be customized according to performance needs.

The inventor found that in order to optimize the performance of the final polycrystalline cubic boron nitride composite sheet, it is necessary to control the total height of the continuous gradient layer. If the total height of the continuous gradient layer is too low, then the continuous gradient is not significant and the effect of alleviating the residual stress is small. If the total height of the continuous gradient layer is too high, then the cost increases and the difficulty of the process enhances.

The inventor found that the gradient function exponent n directly affects the performance of the polycrystalline cubic boron nitride composite sheet. When n is too large or too small, the material does not gradually change smoothly, and problems such as local bonding strength reduction are likely to occur.

In a preferred solution, the cemented carbide in the cemented carbide substrate and the continuous gradient layer is Co—WC, in which a mass fraction of Co is 3 to 25%, and a mass fraction of WC is 75 to 97%. More preferably, the mass fraction of Co in Co—WC is 9 to 13%, and the mass fraction of WC in Co—WC is 87 to 91%.

It is further preferred that the total height H of the continuous gradient layer is 1 to 4 mm, and the exponent n of the gradient functions is 1 to 2.5. Within a further preferred range, the CBN volume fraction in the continuous gradient layer changes smoothly on the side close to the CBN layer, and the CBN content in the overall continuous gradient layer is high, thereby the overall performance of the composite sheet is good.

The disclosure also provides a preparation method for the polycrystalline cubic boron nitride composite sheet having the continuous gradient structure. The method includes the following steps: adding a binder to a CBN powder and a cemented carbide powder respectively and performing ball milling to obtain a CBN slurry and a cemented carbide slurry respectively; putting the two slurries into feeding barrels of a 3D printer respectively and printing a continuous gradient layer green body and a CBN layer green body through mixed feeding from the feeding barrels at two ends; and assembling the CBN layer green body, the continuous gradient layer green body, and the cemented carbide substrate and performing degreasing and sintering under a high temperature and a high pressure to obtain the polycrystalline cubic boron nitride composite sheet.

The inventor found that direct ink writing printing with slurry is necessary to obtain a continuous gradient layer. The disclosure implements the mixing of different slurries in different proportions by utilizing the fluidity characteristics of the slurries, thereby the printing of the continuous gradient structure is achieved.

In a preferred solution, a particle size of the CBN powder is 1 to 100 μm, and a particle size of the cemented carbide powder is 0.5 to 150 μm. More preferably, the particle size of the CBN powder is 40 to 50 μm, and the particle size of the cemented carbide powder is 40 to 50 μm.

In a preferred solution, the binder contains methylcellulose, glycerol, sodium citrate, and water. The binder of the disclosure uses methylcellulose as the main binding component to increase the adhesiveness of the slurry, is supplemented by glycerin as a plasticizer to reduce the viscosity of the slurry and enhance fluidity, and uses sodium citrate as a dispersant to avoid agglomeration phenomenon of micropowder. By using the above binder components, the slurry in the disclosure can ensure the uniformity of the CBN powder and the cemented carbide powder, thereby reducing the agglomeration phenomenon and ensuring the formed quality of 3D printing. A molecular formula of methylcellulose is C₂₀H₃₈O₁₁, and a melting point of methylcellulose is 290-305° C.

In a preferred solution, the binder consists of methylcellulose, glycerin, sodium citrate, and water in mass percentages of 3 to 20%:0.2 to 5%:0.3 to 2%:73 to 87%. More preferably, the binder consists of methylcellulose, glycerin, sodium citrate, and water in mass percentages of 10 to 18%:2 to 3%:1 to 2%:77 to 87%. The inventor confirmed the range of each component through a large number of experiments. The inventor found that the content of each component of the binder should be controlled to work synergistically within a given range, otherwise the printing performance of the slurry is affected.

In a preferred solution, solid contents of the CBN slurry and the cemented carbide slurry are both 40 to 75 wt %. More preferably, the solid contents of the CBN slurry and the cemented carbide slurry are both 50 to 60 wt %.

In a preferred solution, process parameters of the 3D printing are as follows: a layer height is 0.05 to 0.5 mm, a printing speed is 10 to 150 mm/s, an extrusion flow rate is 80 to 180%, and in a process of printing the continuous gradient layer green body through mixed feeding from the feeding barrels at the two ends, a mixed feed ratio of the feeding barrels at the two ends is determined according to the functions (1) and (2). More preferably, the process parameters of the 3D printing are as follows: the layer height is 0.05 to 0.1 mm, the printing speed is 30 to 50 mm/s, the extrusion flow rate is 80 to 100%.

In the actual operation process of the disclosure, the CBN slurry and the cemented carbide slurry are obtained by ball milling and then put into the two feeding barrels of the printer respectively. Also, three-dimensional models of the continuous gradient layer and the CBN layer are established in a three-dimensional modeling software in the computer, and the models are imported into a slicing software for assembly and slicing settings, printing parameter settings, and the mixed feed ratio of the feeding barrels at both ends are set in accordance with the function. After the settings are completed, files are imported into a slurry printer, and a continuous gradient layer green body is printed through the set parameters and mixed feed ratio. At this time, the cemented carbide slurry feed end stops feeding, and the CBN slurry is fed separately to complete printing the CBN layer green body.

In a preferred solution, conditions for the degreasing and the sintering under the high temperature and the high pressure are as follows: a pressure is 3 to 8 GPa, a temperature is 1200 to 1800° C., and a time is 200 to 1000 s. More preferably, the conditions for the degreasing and the sintering under the high temperature and the high pressure are as follows: the pressure is 5.5 to 7 GPa, the temperature is 1600 to 1700° C., and the time is 600 to 700 s.

In the actual operation process, the CBN layer green body, the continuous gradient layer green body, and the cemented carbide substrate that have been dried to constant weight are assembled and put into a high temperature and high pressure resistant round metal cup for compaction. Afterward, the green bodies and the substrate are put into a six-sided hydraulic top press, a pressure is raised to 3 to 8 GPa, a temperature is raised to 1200 to 1800° C., and the pressure and temperature are maintained for 200 to 1000 s. Afterward, the heating is stopped and the pressure is reduced so that the equipment temperature reaches a room temperature. After the pressure drops to standard atmospheric pressure, the polycrystalline cubic boron nitride composite sheet having the continuous gradient structure is obtained by taking out from the six-sided hydraulic top press.

Compared with the related art, the disclosure has the following beneficial effects.

1) The disclosure provides a polycrystalline cubic boron nitride composite sheet having a continuous gradient structure through a continuous gradient layer provided between the CBN layer and the cemented carbide substrate so that volume fractions of the two materials change continuously with exponential functions within one layer, which significantly alleviates the residual thermal stress inside the composite material and changes the stress distribution state inside the polycrystalline cubic boron nitride composite sheet. At the same time, the continuously changing gradient has no notable layered interface, thereby solving the problem of too many interfaces in the layered gradient structure and simultaneously reducing the manufacturing cost of the layered gradient layer.

2) The disclosure uses direct ink writing 3D printing technology with slurry to realize the preparation of the polycrystalline cubic boron nitride composite sheet having the continuous gradient structure. Through implementing the mixing of different slurries in different proportions by utilizing the fluidity characteristics of the slurries, the printing of the continuous gradient structure is achieved.

### BRIEF DESCRIPTION OF THE DRAWINGS

The FIGURE is a schematic diagram of a polycrystalline cubic boron nitride composite sheet having a continuous gradient structure according to an embodiment of the disclosure.

In the FIGURE, reference numeral 1 is a CBN layer, reference numeral 2 is a continuous gradient layer, and reference numeral 3 is a cemented carbide substrate.

### DESCRIPTION OF THE EMBODIMENTS

The disclosure will be further described below with reference to embodiments, but the protection scope of the disclosure is not limited to the following embodiments. Notably, the embodiments described below are merely some of the embodiments, and all other embodiments obtained by persons skilled in the field without creative efforts still fall within the protection scope of the disclosure.

Unless otherwise specified, various raw materials, reagents, instruments, and equipment used in the disclosure may be purchased in the market or prepared by existing methods.

### Example 1

As shown in the FIGURE, the polycrystalline cubic boron nitride composite sheet having the continuous gradient structure consists of three parts, a cemented carbide substrate, a continuous gradient layer, and a CBN layer. In the continuous gradient layer, a total height of the continuous gradient layer is 2 mm, and an exponent n of gradient functions is 1. In the cemented carbide substrate layer, YG13 cemented carbide is adopted, and a mass ratio of raw materials thereof is 87% of WC and 13% of Co. A particle size of the YG13 cemented carbide powder adopted in the continuous gradient layer is 40 to 50 μm, and a particle size of the CBN powder is 40 to 50 μm.

A manufacturing process thereof includes the following steps.

(1) An appropriate amount of the CBN micropowder and the YG13 cemented carbide powder are selected.

(2) A designated binder of a certain proportion is added into the CBN micropowder and the YG13 cemented carbide powder respectively, in which a composition of the binder, in terms of a mass percentage, is as follows: 10% methyl cellulose, 2% glycerin, 1% sodium citrate, and 87% deionized water. The raw materials are put in a planetary ball mill and mixed uniformly at a high speed respectively to obtain slurries whose contents of solid phase (the CBN micropowder, the YG13 cemented carbide powder) are all 60 wt %.

(3) Three-dimensional models of the continuous gradient layer and the CBN layer are established in a three-dimensional modeling software in the computer, and the models are imported into a slicing software for assembly and slicing settings, printing parameter settings, and the mixed feed ratio of the feeding barrels at both ends are set in accordance with the function, in which a layer height is 0.05 mm, a printing speed is 30 mm/s, and an extrusion flow rate is 100%. After the settings are completed, files are imported into a slurry printer, and a continuous gradient layer green body is printed through the set parameters and mixed feed ratio. At this time, the WC—Co slurry feed end stops feeding, and the CBN slurry is fed separately to complete printing the CBN layer.

(4) The CBN layer green body, the continuous gradient layer green body, and the cemented carbide substrate that have been dried to constant weight are assembled sequentially and put into a high temperature and high pressure resistant round metal cup for compaction. Afterward, the green bodies and the substrate are put into a six-sided hydraulic top press, a pressure is raised to 6 GPa, a temperature is raised to 1600° C., and the pressure and temperature are maintained for 600 s. Afterward, the heating is stopped and the pressure is reduced so that the equipment temperature reaches a room temperature. After the pressure drops to standard atmospheric pressure, the polycrystalline cubic boron nitride composite sheet having the continuous gradient structure is obtained by taking out from the six-sided hydraulic top press.

### Example 2

As shown in the FIGURE, the polycrystalline cubic boron nitride composite sheet having the continuous gradient structure consists of three parts, a cemented carbide substrate, a continuous gradient layer, and a CBN layer. In the continuous gradient layer, a total height of the continuous gradient layer is 3 mm, and an exponent n of gradient functions is 1.6. In the cemented carbide substrate layer, YG15 cemented carbide is adopted, and a mass ratio of raw materials thereof is 85% of WC and 15% of Co. A particle size of the YG15 cemented carbide powder adopted in the continuous gradient layer is 40 to 50 μm, and a particle size of the CBN powder is 40 to 50 μm.

A manufacturing process thereof includes the following steps.

(1) An appropriate amount of the CBN micropowder and the YG15 cemented carbide powder are selected.

(2) A designated binder of a certain proportion is added into the CBN micropowder and the YG15 cemented carbide powder respectively, in which a composition of the binder, in terms of a mass percentage, is as follows: 15% methyl cellulose, 3% glycerin, 2% sodium citrate, and 80% deionized water. The raw materials are put in a planetary ball mill and mixed uniformly at a high speed respectively to obtain slurries whose contents of solid phase (the CBN micropowder, the YG15 cemented carbide powder) are all 50 wt %.

(3) Three-dimensional models of the continuous gradient layer and the CBN layer are established in a three-dimensional modeling software in the computer, and the models are imported into a slicing software for assembly and slicing settings, printing parameter settings, and the mixed feed ratio of the feeding barrels at both ends are set in accordance with the function, in which a layer height is 0.1 mm, a printing speed is 50 mm/s, and an extrusion flow rate is 100%. After the settings are completed, files are imported into a slurry printer, and a continuous gradient layer green body is printed through the set parameters and mixed feed ratio. At this time, the WC—Co slurry feed end stops feeding, and the CBN slurry is fed separately to complete printing the CBN layer.

(4) The CBN layer green body, the continuous gradient layer green body, and the cemented carbide substrate that have been dried to constant weight are assembled sequentially and put into a high temperature and high pressure resistant round metal cup for compaction. Afterward, the green bodies and the substrate are put into a six-sided hydraulic top press, a pressure is raised to 5.5 GPa, a temperature is raised to 1600° C., and the pressure and temperature are maintained for 600 s. Afterward, the heating is stopped and the pressure is reduced so that the equipment temperature reaches a room temperature. After the pressure drops to standard atmospheric pressure, the polycrystalline cubic boron nitride composite sheet having the continuous gradient structure is obtained by taking out from the six-sided hydraulic top press.

### Example 3

As shown in the FIGURE, the polycrystalline cubic boron nitride composite sheet having the continuous gradient structure consists of three parts, a cemented carbide substrate, a continuous gradient layer, and a CBN layer. In the continuous gradient layer, a total height of the continuous gradient layer is 4 mm, and an exponent n of gradient functions is 2.5. In the cemented carbide substrate layer, YG9 cemented carbide is adopted, and a mass ratio of raw materials thereof is 91% of WC and 9% of Co. A particle size of the YG9 cemented carbide powder adopted in the continuous gradient layer is 40 to 50 μm, and a particle size of the CBN powder is 40 to 50 μm.

A manufacturing process thereof includes the following steps.

(1) An appropriate amount of the CBN micropowder and the YG9 cemented carbide powder are selected.

(2) A designated binder of a certain proportion is added into the CBN micropowder and the YG9 cemented carbide powder respectively, in which a composition of the binder, in terms of a mass percentage, is as follows: 18% methyl cellulose, 3% glycerin, 1.5% sodium citrate, and 77.5% deionized water. The raw materials are put in a planetary ball mill and mixed uniformly at a high speed respectively to obtain slurries whose contents of solid phase (the CBN micropowder, the YG9 cemented carbide powder) are all 55 wt %.

(3) Three-dimensional models of the continuous gradient layer and the CBN layer are established in a three-dimensional modeling software in the computer, and the models are imported into a slicing software for assembly and slicing settings, printing parameter settings, and the mixed feed ratio of the feeding barrels at both ends are set in accordance with the function, in which a layer height is 0.05 mm, a printing speed is 30 mm/s, and an extrusion flow rate is 100%. After the settings are completed, files are imported into a slurry printer, and a continuous gradient layer green body is printed through the set parameters and mixed feed ratio. At this time, the WC—Co slurry feed end stops feeding, and the CBN slurry is fed separately to complete printing the CBN layer.

(4) The CBN layer green body, the continuous gradient layer green body, and the cemented carbide substrate that have been dried to constant weight are assembled sequentially and put into a high temperature and high pressure resistant round metal cup for compaction. Afterward, the green bodies and the substrate are put into a six-sided hydraulic top press, a pressure is raised to 7 GPa, a temperature is raised to 1700° C., and the pressure and temperature are maintained for 700 s. Afterward, the heating is stopped and the pressure is reduced so that the equipment temperature reaches a room temperature. After the pressure drops to standard atmospheric pressure, the polycrystalline cubic boron nitride composite sheet having the continuous gradient structure is obtained by taking out from the six-sided hydraulic top press.

In the above embodiments, the CBN layer and the cemented carbide substrate in the polycrystalline cubic boron nitride composite sheets with different continuous gradient structures remain unchanged, and only the thickness of the transition layer (the continuous gradient layer) changes. The dimensions of the CBN layer and the cemented carbide substrate in the ordinary composite sheet are consistent with the dimensions of the CBN layer and the cemented carbide substrate in the polycrystalline cubic boron nitride composite sheet with continuous gradient structure in Example 1, except that the gradient transition layer (the continuous gradient layer) is not included. The comparison results of the residual stress of the polycrystalline cubic boron nitride composite sheet in the above embodiments and the residual stress of an ordinary polycrystalline cubic boron nitride composite sheet are shown in Table 1 below, wherein the positive value of residual stress represents the tensile stress, and the negative value of residual stress represents the compressive stress.

TABLE 1
Measurement results of interface residual stress of
polycrystalline cubic boron nitride composite sheets

| | | Amount of | |
|---|---|---|---|
| Position | | Stress (GPa) | |
| Ordinary | CBN layer with cemented | 3.7 | GPa |
| composite sheet | carbide substrate | | |
| Example 1 | continuous gradient layer | 1.7 | GPa |
| | and CBN layer | | |
| | continuous gradient layer | −1.2 | GPa |
| | and cemented carbide | | |
| | substrate | | |
| Example 2 | continuous gradient layer | 1.3 | GPa |
| | and CBN layer | | |
| | continuous gradient layer | −0.8 | GPa |
| | and cemented carbide | | |
| | substrate | | |
| Example 3 | continuous gradient layer | 1.8 | GPa |
| | and CBN layer | | |
| | continuous gradient layer | −1.5 | GPa |
| | and cemented carbide | | |
| | substrate | | |

It may be seen from the above test results that compared with the ordinary composite sheet, the composite sheets prepared in Example 1 to Example 3 according to embodiments of the disclosure have smaller residual stress and higher interface bonding strength.

### Comparative Example

In the Comparative Example, merely certain experimental parameters are changed, and other experimental conditions are the same as in Example 1. The comparative results are shown in Table 2 below.

TABLE 2
Comparative experiment results table

| No. | Changed condition | Changed parameters | Results compared |
|---|---|---|---|
| 1 | The continuous | The continuous gradient | 1. The process steps are significantly |
| | gradient layer | layer is changed to a | more complicated. |
| | | three-layer hierarchical | 2. There is a large residual stress |
| | | gradient structure, | reaching 2 GPa at the interface of the |
| | | wherein the CBN | hierarchical gradient layer, and the |
| | | volume content of the | interface bonding is weak. |
| | | three gradient layers | |
| | | is 25%, 50% and 75% | |
| | | from bottom to top, | |
| | | respectively. The | |
| | | thickness of the three | |
| | | gradient layers is equal, | |
| | | with a total thickness of | |
| | | 2 mm. | |
| 2 | Gradient function | 0.5 | The residual stress of the cemented |
| | exponent n | | carbide substrate of the continuous |
| | | | gradient layer changes from compressive |
| | | | stress to tensile stress, and the bonding |
| | | | strength decreases. |
| 3 | Glycerin content | 0% | The slurry has a poor thixotropy, rough |
| | | | feel, and is difficult to print. |
| 4 | CBN powder particle | 0.1 μm | There is a significant agglomeration |
| | size | | phenomenon in the prepared slurry, and |
| | | | the print effect is poor. |

What is claimed is:

1. A polycrystalline cubic boron nitride composite sheet having a continuous gradient structure, wherein the polycrystalline cubic boron nitride composite sheet consists of a cemented carbide substrate, a continuous gradient layer, and a CBN layer from bottom to top, the continuous gradient layer comprises cemented carbide and CBN, a content of the CBN increases in continuous gradient from bottom to top, a content of the cemented carbide decreases in continuous gradient from bottom to top, and in the continuous gradient layer, at a height h and from bottom to top, a volume fraction D of the CBN and a volume fraction M of the cemented carbide satisfy gradient functions (1) and (2) respectively:
$$D = {( \frac{h}{H} )}^{n} , 0 ≦ h ≦ H \qquad ( 1 )$$
$$M = 1 - {( \frac{h}{H} )}^{n} , 0 ≦ h ≦ H \qquad ( 2 )$$
wherein in the functions (1) and (2), H is a total height of the continuous gradient layer, and n is an exponent of the gradient functions (1) and (2); and
the total height H of the continuous gradient layer is 0.05 to 5 mm, and the exponent n of the gradient functions (1) and (2) is greater than or equal to 1.

2. The polycrystalline cubic boron nitride composite sheet having the continuous gradient structure as claimed in claim 1, wherein the cemented carbide in the cemented carbide substrate and the continuous gradient layer is Co—WC, a mass fraction of Co is 3 to 25%, and a mass fraction of WC is 75 to 97%.

3. The polycrystalline cubic boron nitride composite sheet having the continuous gradient structure as claimed in claim 2, wherein the total height H of the continuous gradient layer is 1 to 4 mm, and the exponent n of the gradient functions (1) and (2) is 1 to 2.5.

4. A preparation method of the polycrystalline cubic boron nitride composite sheet having the continuous gradient structure as claimed in claim 1, comprising:
adding a binder to a CBN powder and a cemented carbide powder respectively and performing ball milling to obtain a CBN slurry and a cemented carbide slurry respectively;
putting the two slurries into feeding barrels of a 3D printer respectively and printing a continuous gradient layer green body and a CBN layer green body through mixed feeding from the feeding barrels at two ends; and
assembling the CBN layer green body, the continuous gradient layer green body, and the cemented carbide substrate and performing degreasing and sintering under a high temperature and a high pressure to obtain the polycrystalline cubic boron nitride composite sheet.

5. The preparation method of the polycrystalline cubic boron nitride composite sheet having the continuous gradient structure as claimed in claim 4, wherein a particle size of the CBN powder is 1 to 100 μm, and a particle size of the cemented carbide powder is 0.5 to 150 μm.

6. The preparation method of the polycrystalline cubic boron nitride composite sheet having the continuous gradient structure as claimed in claim 4, wherein the binder comprises methylcellulose, glycerol, sodium citrate, and water.

7. The preparation method of the polycrystalline cubic boron nitride composite sheet having the continuous gradient structure as claimed in claim 6, wherein the binder consists of methylcellulose, glycerin, sodium citrate, and water in mass percentages of 3 to 20%:0.2 to 5%:0.3 to 2%:73 to 87%.

8. The preparation method of the polycrystalline cubic boron nitride composite sheet having the continuous gradient structure as claimed in claim 4, wherein solid contents of the CBN slurry and the cemented carbide slurry are both 40 to 75 wt %.

9. The preparation method of the polycrystalline cubic boron nitride composite sheet having the continuous gradient structure as claimed in claim 4, wherein process parameters of the 3D printing are as follows: a layer height is 0.05 to 0.5 mm, a printing speed is 10 to 150 mm/s, an extrusion flow rate is 80 to 180%, and in a process of printing the continuous gradient layer green body through mixed feeding from the feeding barrels at the two ends, a mixed feed ratio of the feeding barrels at the two ends is determined according to the functions (1) and (2).

10. The preparation method of the polycrystalline cubic boron nitride composite sheet having the continuous gradient structure as claimed in claim 4, wherein conditions for the degreasing and the sintering under the high temperature and the high pressure are as follows: a pressure is 3 to 8 GPa, a temperature is 1200 to 1800° C., and a time is 200 to 1000 s.
